(19) United States
(12) Patent Application Publication
(10) Pub. No.: US 2012/0143717 A1
(43) Pub. Date: Jun. 7, 2012

(54) Embroidery Design Transactional Systems and Methods

(75) Inventor: Gary Allen Gardner, Dallas, TX (US)

(73) Assignee: Action Tapes, Inc., Dallas, TX (US)

(21) Appl. No.: 12/958,850

(22) Filed: Dec. 2, 2010

(51) Int. Cl. G06Q 30/00; D05B 21/00; D05C 5/06

(52) U.S. Cl. 705/26.5; 112/475.19; 112/102.5

(57) ABSTRACT

Embroidery design transactional systems and methods are provided. In one embodiment, a method for conducting embroidery design transactions includes receiving an embroidery design inputted by a user of a communication device to form a user-customized embroidery design. The user is associated with a user account. The method includes saving the user-customized embroidery design on the communication device in response to receiving a save request from the user to save the user-customized embroidery design on the communication device. The method also includes initiating a monetary charge to the user account in response to saving the user-customized embroidery design on the communication device.

### TECHNICAL FIELD

The illustrative embodiments relate generally to embroidery design, and more particularly, to embroidery design transactional systems and methods.

### BACKGROUND

Advances in computer technology have been adopted by the embroidery field to enhance the means by which embroidery patterns are created. In a technique referred to in the market as digitizing, a computer application may be used to place stitches, embroidery lettering, motifs, etc. to form an embroidery design. However, current digitizing applications may be costly and require a user to purchase an expensive piece of software when, in fact, actual usage by the user of the application is relatively low. Also, current digitizing applications fail to allow a consumer to flexibly and conveniently purchase customized embroidery designs that can later be utilized by the user's embroidery machine or other device.

### SUMMARY

According to an illustrative embodiment, a method for conducting embroidery design transactions includes receiving an embroidery design inputted by a user of a communication device to form a user-customized embroidery design. The user is associated with a user account. The method includes saving the user-customized embroidery design on the communication device in response to receiving a save request from the user to save the user-customized embroidery design on the communication device. The method also includes initiating a monetary charge to the user account in response saving the user-customized embroidery design on the communication device.

According to another illustrative embodiment, a method for deploying computer readable code for conducting embroidery design transactions to a user includes receiving a user request for an embroidery application. The embroidery application includes computer usable program code to receive an embroidery design inputted by a user of a communication device to form a user-customized embroidery design. The use is associated with a user account. The embroidery application also includes computer usable program code to convert the user-customized embroidery design to a user-defined file format, save the user-customized embroidery design on the communication device in response to receiving a save request from the user to save the user-customized embroidery design on the communication device, and initiate a charge to the user account for the user-customized embroidery design created using the embroidery application in accordance with a transactional scheme when the computer usable program code is deployed in the communication device. The method also includes deploying the embroidery application to the communication device.

According to another illustrative embodiment, an embroidery design transactional system includes an embroidery application implementable on a communication device. The embroidery application includes an embroidery design editor to receive input from a user of the communication device to form a user-customized embroidery design. The user is associated with a user account. The embroidery application also includes an embroidery design saving module to save the user-customized embroidery design on the communication device, and an embroidery design transaction module to initiate a charge to the user account in accordance with a transactional scheme.

### BRIEF DESCRIPTION OF THE DRAWINGS

FIG. 1 is a schematic, pictorial representation of an embroidery design transactional system according to an illustrative embodiment;

FIG. 2 is a schematic diagram showing the interaction between elements in FIG. 1 according to an illustrative embodiment;

FIG. 3 is a schematic, block diagram of an embroidery design transactional system according to an illustrative embodiment;

FIG. 4 is a flowchart of a process for conducting embroidery design transactions according to an illustrative embodiment;

FIG. 5 is a flowchart of a process for conducting embroidery design transactions according to another illustrative embodiment; and

FIG. 6 is a schematic, block diagram of a data processing system in which the illustrative embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims.

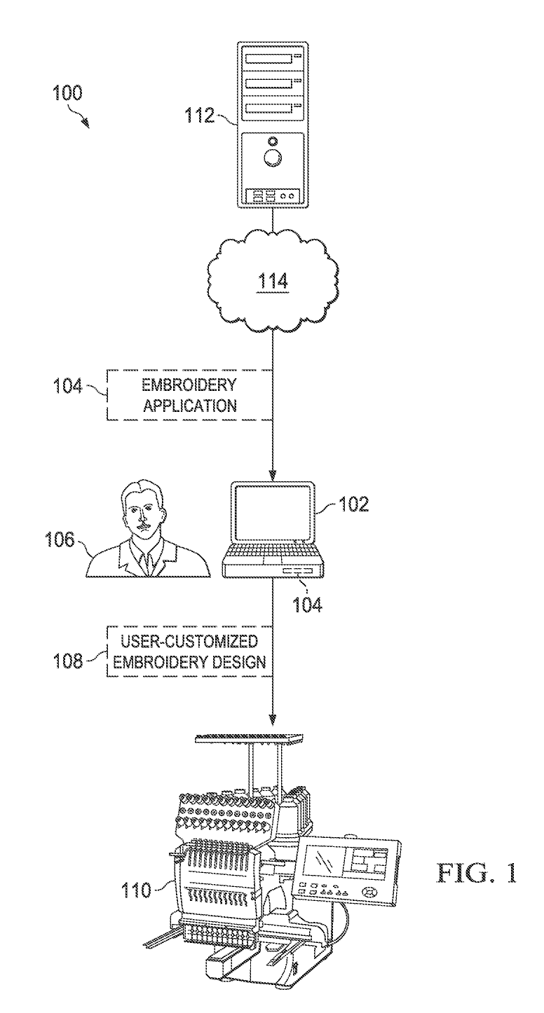

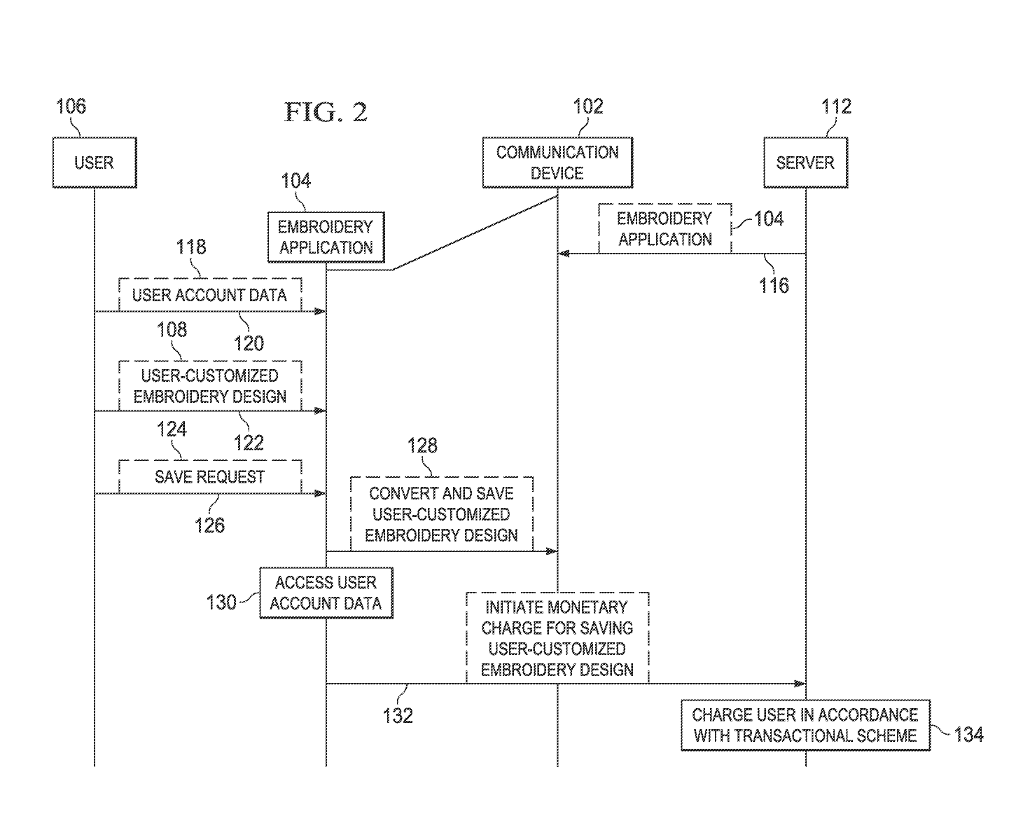

Referring to FIGS. 1 and 2, an illustrative embodiment of an embroidery design transactional system 100 includes a communication device 102 on which an embroidery application 104 may be installed. Unless otherwise indicated, as used herein, “or” does not require mutual exclusivity. After installing the embroidery application 104 on the communication device 102, a user 106 may use the embroidery application 104 to design a user-customized embroidery design 108, a process that may be referred to as “digitizing”. Once the user 106 has created the user-customized embroidery design 108 using the embroidery application 104, the user 106 may save the user-customized embroidery design 108 on the communication device 102 as a file in any desired file format. In one example, the user 106 may save the user-customized embroidery design 108 in a file format that is compatible with or usable on an embroidery, or sewing, machine 110. The embroidery machine 110 may be the machine on which the user 106 intends to use to embroider the user-customized embroidery design 108. The embroidery machine 110 may be any machine capable of embroidering, sewing, or otherwise stitching an embroiderable medium, such as fabric.

The embroidery application 104 may charge the user 106, monetarily or otherwise, for designing or saving the user-customized embroidery design 103 on the communication device 102 using a transactional scheme. Non-limiting examples of transactional schemes that may be used by the illustrative embodiments are described in detail below. In one non-limiting example, a pay-per-design transactional scheme may be used in which the user 106 incurs a monetary charge each time the user 106 saves a user-customized embroidery design 108 on the communication device 102. To illustrate this transactional scheme, the user 106, after installing the embroidery application 104 on his or her communication device 102, may design one or more user-customized embroidery designs 108 for use on his or her embroidery machine 110. The user 106 will then be charged a predetermined fee for each of the user-customized embroidery designs 108 that the user 106 saves on the communication device 102. This predetermined fee may include the conversion of each of the user-customized embroidery designs 108 to a file having a particular file format, such as a file format compatible with the user's embroidery machine 110.

In the non-limiting example of FIG. 1, the embroidery application 104 is shown to have been deployed to the communication device 102 from a server 112, which may be one or more Internet servers, network servers, or other types of servers. In this embodiment, the user 106, via the communication device 102, may request or download the embroidery application 104 from the server 112. In response, the server 112 may send the embroidery application 104 to the communication device 102 via a data communication medium 114. In other embodiments, instead of deploying or downloading the embroidery application 104 onto the communication device 102, the embroidery application 104 may be installed or transferred on the communication device 102 using a physical medium, such as a compact disk (CD), Universal Serial Bus (USB) device, or any other storage device capable of storing the embroidery application 104.

Referring specifically now to FIG. 2, an illustrative embodiment of an interaction between the elements of the embroidery design transactional system 100 of FIG. 1 is shown in which the server 112 deploys the embroidery application 104 to the communication device 102 (data communication 116). Once the embroidery application 104 is installed on the communication device 102, the user 106 may input his or her user account data 118 to the embroidery application 104 (data communication 120). As explained below, the user account data 118 may include user financial data such as the user's credit or debit card numbers. The user financial data may be used to monetarily, or otherwise, charge the user 106 in accordance with the illustrative embodiments.

The user 106 may then design, upload, or otherwise input a user-customized embroidery design 108 using the embroidery application 104. Designing the user-customized embroidery design 108 may involve the placement or editing of stitches, embroidery lettering, motifs, or any other elements that may form part of an embroidery design (data communication 122).

Upon completing the user-customized embroidery design 108, the user 106 may input a save request 124 to the embroidery application 104 (data communication 126). In response, the embroidery application 104 may then convert and/or save the user-customized embroidery design 108 on the storage of the communication device 102 (data communication 128). In the embodiment in which the user-customized embroidery design 108 is converted to a file having a particular file format, the file format may be determined by the user 106, the embroidery application 104, or any other source.

As will be described in further detail below, the transactional scheme used by the embroidery application 104 may vary depending on the embodiment. The illustrative embodiment of FIG. 2 shows one non-limiting example of a pay-per-design transactional scheme in which the user 106 is monetarily charged for each user-customized embroidery design 108 that he or she converts and saves onto the communication device 102. In FIG. 2, after the user 106 saves the user-customized embroidery design 108 onto the communication device 102, the embroidery application 104 may access the user account data 118 (process 130). The embroidery application 104 may then initiate a monetary charge for saving the user-customized embroidery design 108 by communicating with the server 112 (data communication 132). The server may then charge the user 106 in accordance with the transactional scheme by charging the user 106 for the saved user-customized embroidery design 108 (process 134).

The communication device 102 may be any device capable of executing the embroidery application 104. For example, the communication device 102 may be a computer (e.g., a laptop, netbook, tablet computer, desktop computer, or minicomputer), a cellular phone (e.g., a smart phone), a personal digital assistant, a kiosk, a portable gaming device, a web browsing device, a media player, or any other electronic device capable of executing the embroidery application 104.

The techniques, technologies, or media by which the components of the embroidery design transactional system 100 intercommunicate are numerous. For example, the embroidery design transactional system 100, or any portion thereof, may be part of a personal area network (PAN), a local area network (LAN), a campus area network (CAN), a metropolitan area network (MAP), or any other network type. Also, communication between any two of the elements in the embroidery design transactional system 100 may be direct or indirect. Data communication medium 114 between the server 112 and the communication device 102 may be any medium through which data can be communicated. For example, the data communication medium 114 may be wired or wireless data connections, and may utilize a virtual private network (VPN), multi-protocol label, switching (MPLS), the Internet, or any other data communication media. If applicable, wireless communication between the communication device 102 and the server 112 may utilize any wireless standard for communicating data, such as CDMA (e.g., cdmaOne or CDMA2000), GSM, 3G, 4G, Edge, an over-the-air network, Bluetooth, etc. Any of the transactions occurring in the embroidery design transactional system 100 may be performed using secure SSL transactions.

In one example, the embroidery design transactional system 100 may utilize the Internet, with any combination of the data communication medium 114 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. FIGS. 1 and 2 are intended as examples, and not as an architectural limitation for the different illustrative embodiments.

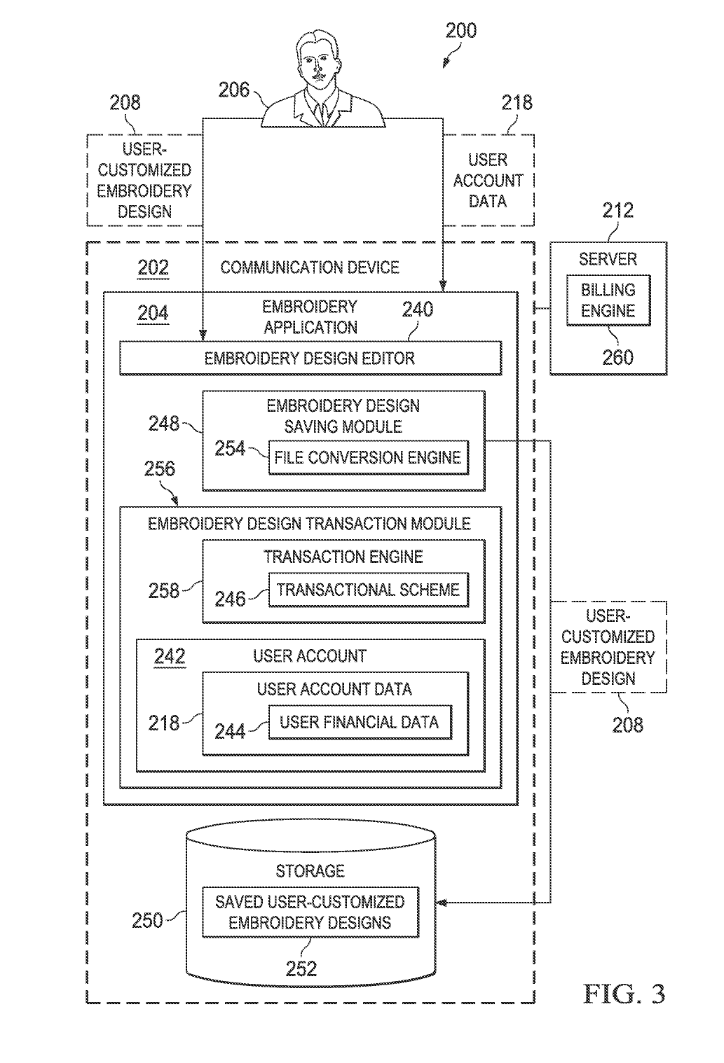

Referring to FIG. 3, an illustrative embodiment of the embroidery design transactional system 200 is shown in which the embroidery application 204 has been installed on the communication device 202. Elements of FIG. 3 that are analogous to elements in FIGS. 1 and 2 have been shown by indexing the reference numerals by 100. The embroidery application 204 may be partially or fully implemented on the communication device 202. In the embodiment in which the embroidery application 204 is partially implemented by the communication device 202, the various modules or elements of the embroidery application 204 may be implemented or distributed across two or more devices (e.g., the communication device 202 and the server 212).

The embroidery application 204 includes an embroidery design editor 240, which allows the user 206 to create or edit the user-customized embroidery design 208. The embroidery design editor 240 may receive input related to the creation or design of the user-customized embroidery design 208, including, but not limited to, the following examples: placement, selection, movement, revision, or deletion of stitches, embroidery lettering, motifs, threads, colors, or any other elements or attributes of an embroidery design; selection or modification of stitch types (e.g., satin, run, fill, bean, etc.); merging of existing designs; selection of the order and path of design elements; changing the order of design elements; using rough art and manually adjusting point placement; performing color blending with graduate fill; copying, pasting, rotating, or mirroring of entire designs or segments, changing underlay and stitch type, length, and direction; controlling pull compensation on satin and fill stitches; controlling entry and exit points; inserting pattern or motif fills into existing designs when combined with a pattern fill; re-sequencing stitching order of design elements with, e.g., a drop and drag feature; reshaping any existing design; etc.

Although the embroidery design editor 240 is shown as being part of the embroidery application 204, in another embodiment the embroidery design editor 240 is a separate application that works in conjunction with the embroidery application 204; in this embodiment, the embroidery design editor 240 may be responsible for the creation or editing of the user-customized embroidery design 208, while the embroidery application 204 manages transactions, monetary and otherwise, involving the user-customized embroidery design 208.

In one embodiment, the embroidery application 204 may maintain a user account 242 for the user 206, which contains the user account data 218. The user account data 218 may be inputted by the user 206 directly via the communication device 202, or may be obtained from another source storing this data. Upon receiving the user account data 218, the embroidery application 204 may associate the user account data 218 to the user account 242 for the user 206. The user account data 218 may include any data related to the user 206, such as the user's identifying information (e.g., name, social security number, etc.), contact information (e.g., physical address, e-mail address, etc.), embroidery design preferences, preferred or owned embroidery machine(s), preferred file format(s), prefer transactional scheme(s), time spent using the embroidery application 204, preferred customer status, etc. Also, the user account data 218 may be inputted by the user 206 anytime after the embroidery application 204 is installed on the communication device 202, including before or after the creation of the user-customized embroidery design 208 using the embroidery design editor 240.

The user account data 218 may also include user financial data 244. The user financial data 244 may be used to charge or bill the user 206 in accordance with the transactional scheme 246 used by the illustrative embodiments. Non-limiting examples of the kinds of user financial data 244 that may be recorded in the user account 242 include credit or debit card data for the user 206, banking data, routing number data, fund wiring data, gift card data, billing data (e.g., billing address), prepayment data, or any other financial data usable in a financial transaction. As with the other types of user account data 218, the user financial data 244 may be directly entered by the user 206 or obtained from another source.

The embodiment of FIG. 3 shows that the user account 242 is maintained or stored locally by the embroidery application 204. However, in other embodiments, the user account 242 may be maintained or stored at a location other than the communication device 202 or the embroidery application 204. For example, the user account 242 may be maintained at the server 212, which is in data communication with, but physically separate from, the communication device 202.

The embroidery application 204 may include an embroidery design saving module 248 that is operable to save the user-customized embroidery design 208 to a storage 250 of the communication device 202. The storage 250 may contain, among other things, all or a portion of the saved user-customized embroidery designs 252 that have been saved by the embroidery design saving module 248. The embroidery design saving module 248 may save the user-customized embroidery design 208 in response to receiving a save request from the user 206. Such a save request may be inputted by the user 206, for example, after the user 206 has finished designing the user-customized embroidery design 208 using the embroidery design editor 240.

The embroidery design saving module 248 may also include a file conversion module 254 that is operable to convert the user-customized embroidery design 208 to a file that has a particular file format. This converted file may then be saved onto the storage 250 by the embroidery design saving module 248. In one embodiment, the file conversion engine 254 converts the user-customized embroidery design 208 to a user-defined file format. In this embodiment, a user selection of the file format may be received by the embroidery application 204 prior to converting the user-customized embroidery design 208, and such user selection may be stored as part of the user account data 218. As mentioned above, in one example, the user-defined file format may be a file format that is compatible for usage with an embroidery machine that is associated with the user 206 so that the user 206 can embroider his or her design.

In other embodiments, the file format into which the file conversion engine 254 converts the user-customized embroidery design 208 may be predetermined by the embroidery application 204. In another embodiment, an embroidery machine in data communication with the embroidery application 204 or the communication device 202 may communicate, to the embroidery application 204, the file format(s) with which the embroidery machine is compatible, thereby determining the file format into which the file conversion engine 254 converts the user-customized embroidery design 208.

The file format into which the file conversion engine 254 converts the user-customized embroidery design 208 may be any format usable on any embroidery machine, and non-limiting examples include: CND, CSD, DAT, DSB, DST, DSZ, EXP, HUS, JEF, KSM, PCM, PCS, PES, SHV, TAP, UXY, VIP, XXX, ZSK, POF, EMB, or ART. Once the file conversion engine 254 has converted the user-customized embroidery design 208 into a file having the specified file format, the embroidery design saving module 248 may save the converted file onto the storage 250.

The embroidery application 204 also includes an embroidery design transaction module 256 that manages the transactions implemented by the embroidery application 204. In the embodiment in which the user account 242 is maintained by the embroidery application 204, the embroidery design transaction module 256 may include the user account 242 to help facilitate the transactions managed by the embroidery application 204.

The embroidery design transaction module 256 may also include a transaction engine 258. In one embodiment, the transaction engine 258 is operable to initiate a charge, monetary or otherwise, to the user account 242 in accordance with the transactional scheme 246. The transactional scheme 246 may be selected by the user 206, or otherwise predetermined by the embroidery application 204 or administrator thereof. In an alternative embodiment, the embroidery design transaction module 256 may implement the monetary charge, or execute any other aspects of the transaction, using a third-party transaction application, such as PayPal, EasyCharge, Google Checkout, Wirecard, Moneybookers, The Instant Pay, 2Checkout.com, CCNow, Kaui, or any other transaction service or application.

Several examples of transaction schemes 246 follow by way of illustration, but other transactional schemes, or combinations of those described herein, may also be implemented by the embroidery application 204. In one embodiment, the transactional scheme 246 may be a pay-per-design scheme. In a pay-per-design transactional scheme, the transaction engine 258 may initiate a single monetary charge to the user account 242, using the user financial data 244, for each user-customized embroidery design 208 saved to the communication device 202. The conversion of the user-customized embroidery design 208 by the file conversion engine 254 may be part of the single monetary charge, or may be charged separately, depending on the embodiment. In one example, the user 206 may be charged for saving the user-customized embroidery design 208, and then be subject to one or more subsequent charges each time the user 206 converts the saved user-customized embroidery design into a different file format.

Thus, to take a specific example, if the user 206 designs the user-customized embroidery design 208 using the embroidery application 204, the user account 242 may be charged a fee when the user 206 saves and/or converts the user-customized embroidery design 208 on the communication device 202. If the user 206 subsequently creates another user-customized embroidery design, the user account 242 will incur a subsequent monetary charge for the saving and/or conversion of the second user-customized embroidery design. In this manner, the user 206 pays for each user-customized embroidery design saved on the communication device 202 using the embroidery application 204. In one non-limiting embodiment, the embroidery application 204 may be provided to the user 206 at no charge, and the user 206 may then incur charges based on the number of user-customized embroidery designs 208 saved by the user 206 on the communication device 202. In another embodiment, the user 206 may be monetarily charged for each embroidery design that the user 206 uploads and converts using the embroidery application 204. In another embodiment, the user 206 may be monetarily charged, separately or inclusively, for transmitting, over a data network, the user-customized embroidery design 208 to an embroidery machine.

The monetary amount that is charged to the user account 242 for saving the user-customized embroidery design 208 may be variable or fixed. In a fixed, or flat, fee example, the embroidery application 204, or administrator thereof, may determine the fixed fee that is charged to the user account 242 for each user-customized embroidery design 208 saved by the embroidery application 204. In the variable fee example, the monetary charge for each user-customized embroidery design 208 may be dependent upon one or more criterion or factors. For example, the transaction engine 258 may determine a monetary charge amount for saving the user-customized embroidery design 208 based a number of stitches contained in the user-customized embroidery design 208. Such stitch information may be supplied by the embroidery design editor 240 to the transaction engine 258. The monetary charge amount may increase as the number of stitches in the user-customized embroidery design 208 increases. In this manner, more complex embroidery designs may cost more to the user 206. By way of non-limiting example, the user 206 may be charged a first amount if the user-customized embroidery design 208 has between 1 and 10,000 stitches, a second, higher amount if the user-customized embroidery design 208 has between 10,001 and 50,000 stitches, and a third, even higher amount if the user-customized embroidery design 208 has 50,001 or more stitches; these ranges and prices may vary depending on the embodiment. Whatever the determined charge amount, the transaction engine 258 may initiate the monetary charge to the user account 242 for the determined monetary charge amount. Other factors that may be used to determined the monetary charge amount include the file size of the user-customized embroidery design 208, the amount of time spent on the embroidery design editor 240 to create the user-customized embroidery design 208, and/or any other factor.

In another embodiment, the transactional scheme 246 may be a subscription scheme in which the user 206 subscribes to the right to use the embroidery application 204 for a period of time. For example, the user 206 may he charged monthly by the transaction engine 258 for a subscription for the usage of the embroidery application 204, thereby allowing the user 206 create, convert, and/or save a fixed or unlimited number of user-customized embroidery designs 208 using the embroidery application 204. The predetermined time interval at which the user account 242 is charged may vary (e.g., daily, weekly, monthly, yearly, etc.).

In the case in which the user 206 is entitled to only a fixed number of saved user-customized embroidery designs 252 during the subscription period, a number of allocated credits, or points, may determine the exact number of saved user-customized embroidery designs 252 to which the user 206 is entitled. The number of credits used for each saved user-customized embroidery design 252 may vary based on any number of factors, such as those mentioned above (e.g., number of stitches, file size, time spent on embroidery design editor 240, etc.). The transaction engine 258 may then deduct credits as the user 206 saves his or her user-customized embroidery designs 208.

In another embodiment, the user 206 may pay a periodical fee (e.g., monthly fee) for the ability to place or edit a predetermined number of stitches during a period (e.g., one month). For example, the user 206 may be charged a predetermined monthly amount for the ability to place or edit 50,000 stitches per month, as well as the ability to save the user-customized embroidery design(s) 208 resulting therefrom.

In another embodiment, the transactional scheme 246 may be a bulk purchase scheme that allows the user 206 to save a predetermined or purchased number of user-customized embroidery designs 208 on the communication device 202. The transaction engine 258 may charge the user account 242 a monetary amount based on the number of user-customized embroidery designs 208 purchased as part of the bulk purchase scheme (e.g., 5 designs, 10 designs, 20 designs, etc,). Also, each time the user 206 saves the user-customized embroidery design 208, instead of initiating a monetary charge to the user account 242, the transaction engine 258 may decrement the current number of user-customized embroidery designs to which the user 206 is entitled at any given time. For example, if the user 206 has 6 (six) user-customized embroidery designs left in his or her account 242, the next time the user 206 saves a user-customized embroidery design 208, the transaction engine 258 may decrement the current number of user-customized embroidery designs to which the user is entitled to 5 (five).

In another embodiment of the bulk purchase transactional scheme, the use 206 may purchase points or credits that may be redeemed toward the creation, editing, or saving of user-customized embroidery designs 208. In this embodiment, each time the user 206 creates and saves a user-customized embroidery design 208, a fixed or variable number of points or credits may be deducted from the user's account. In one example, each point or credit may be redeemed by the user 206 toward a predetermined number of stitches, in which case more points will be deducted from the user's account as the number of stitches in a user-customized embroidery design 208 increases. As discussed above, a point or credit system may also be adapted for usage in a subscription transactional scheme.

In another embodiment, the transactional scheme 246 may be a time-based scheme in which the transaction engine 258 initiates a monetary charge to the user account 242 based on an amount of time the user 206 uses the embroidery application 204. For example, the user 206 may be charged per minute, per hour, etc that he or she uses the embroidery design editor 240 to design his or her user-customized embroidery design 208. In one example, the period of time for which the user 206 is charged may end at the time the user 206 saves the user-customized embroidery design 208 or logs off from using the embroidery application 204.

When the transaction engine 258 initiates a charge, monetary or otherwise, the transaction engine 258 may send a charge request to a billing engine 260, which actually charges the user account 242 for the determined charge using the user financial data 244. The billing engine 260 may be implemented on either or both of the communication device 202 or a device other than the communication device 202, such as the server 212.

In another embodiment, in addition to or in lieu of being charged for the creation or storage of the user-customized embroidery designs 208, the user 206 may be charged for editing an existing design. For example, the user 206 may be charged a monetary amount of editing one of the saved user-customized embroidery designs 252 already stored on storage 250 of the communication device 202. The charge for editing the saved user-customized embroidery design 252 may be determined using any of the transactional schemes 246 described above, or any combination thereof.

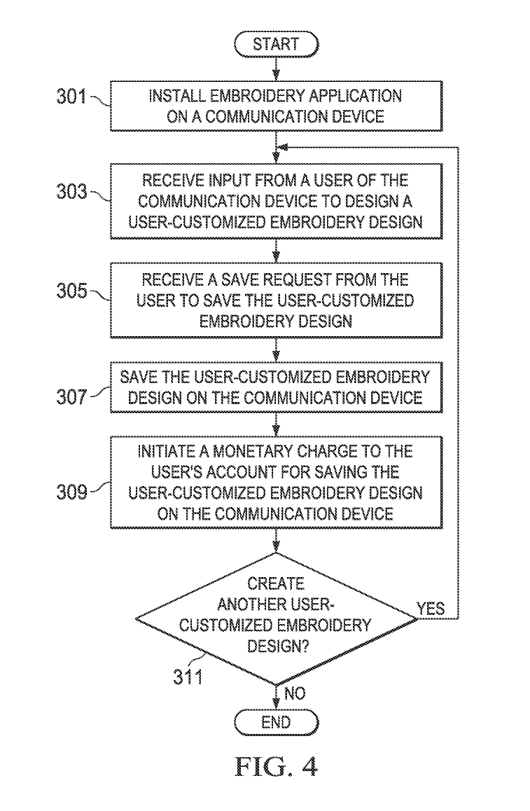

Referring to FIG. 4, an illustrative embodiment of a process for conducting embroidery design transactions, which may be implemented by the embroidery application 104 or 204 illustrated in FIGS. 1 through 3, includes installing an embroidery application on the communication device (step 301). The process receives input from a user of the communication device to design a user-customized embroidery design (step 303). The process receives a save request from the user to save user-customized embroidery design (step 305). The process saves the user-customized embroidery design on the communication device (step 307). The process initiates a monetary charge to the user's account for saving the user-customized embroidery design on the communication device (step 309).

The process determines whether to create another user-customized embroidery design (step 311). Whether to create another user-customized embroidery design may be determined by the user. If the process determines not to create another user-customized embroidery design, the process may terminate. If the process determines to create another user-customized embroidery design, the process may return to step 303.

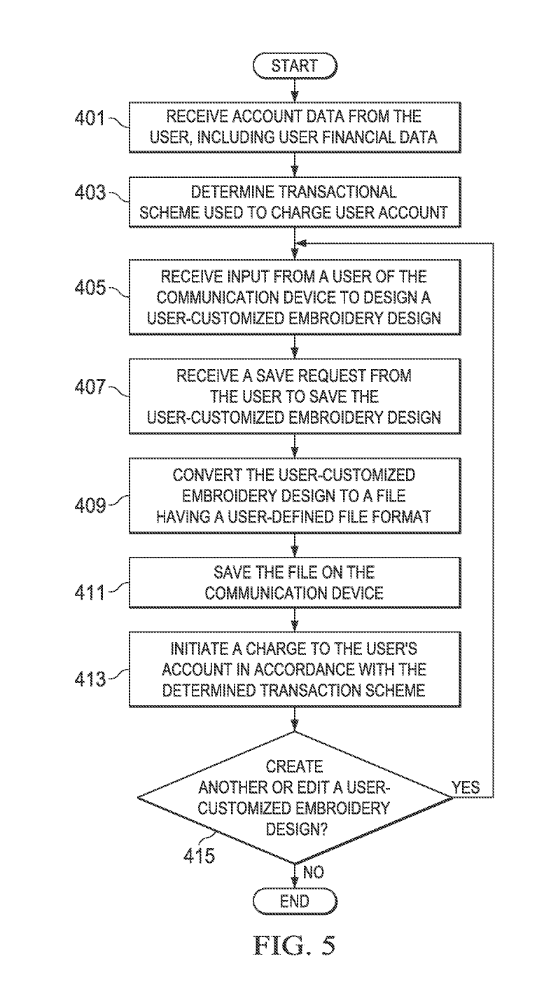

Referring to FIG. 5, an illustrative embodiment of a process for conducting embroidery design transactions, which may be implemented by the embroidery application 104 or 204 in FIGS. 1 through 3, includes receiving account data from the user, including user financial data (step 401). The process determines a transactional scheme to be used for charging the user account (step 403). The process receives input from the user of the communication device to design a user-customized embroidery design (step 405). The process receives a save request from the user to save the user-customized embroidery design (step 407). The process converts the user-customized embroidery design to a file having a user-defined file format (step 409). As described above, the file format may also be defined by an entity other than the user.

The process saves the file on the communication device (step 411). The process initiates a charge to the user's account in accordance with the determined transaction scheme (step 413). The initiation of the charge, as described in step 413, may occur at any point in the process of FIG. 5, depending upon the transactional scheme being used in the embodiment. The process determines whether to create another or edit a user-customized embroidery design (step 415). If the process determines not to create another or edit a user-customized embroidery design, as determined or specified by the user, the process may terminate. If the process determines to create another or edit a user-customized embroidery design, the process may then return to step 405.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the Figures. For example, in some cases, two blocks shown in succession may be executed substantially concurrently, or the blocks may sometimes be executed in the reverse order, depending upon the functionality involved.

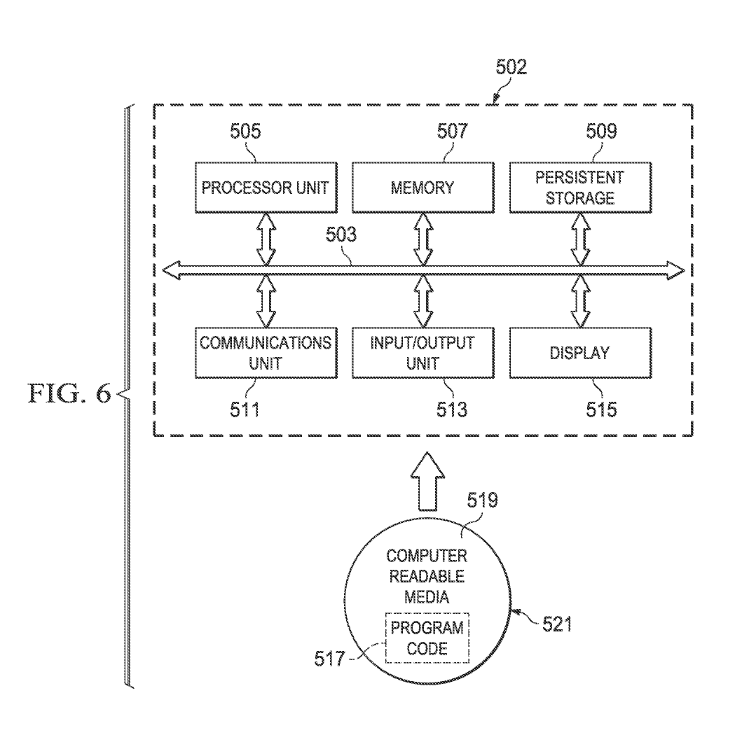

Referring to FIG. 6, a block diagram of a computing device 502 is shown in which the illustrative embodiments may be implemented. The computing device 502 may be the communication device 102 or 202 described in FIGS. 1 through 3. In another embodiment, the embroidery application 104 or 204 described in FIGS. 1 through 3 may be implemented on the computing device 502. Computer-usable program code or instructions implementing the processes used in the illustrative embodiments may be located on the computing device 502. The computing device 502 includes a communications fabric 503, which provides communications between a processor unit 505, a memory 507, a persistent storage 509, a communications unit 511, an input/output (I/O) unit 513, and a display 515.

The processor unit 505 serves to execute instructions for software that may be loaded into the memory 507. The processor unit 505 may be a set of one or more processors or may be a multi-processor core, depending on the particular implementation. Further, the processor unit 505 may be implemented using one or more heterogeneous processor systems in which a main processor is present with secondary processors on a single chip. As another illustrative example, the processor unit 505 may be a symmetric multi-processor system containing multiple processors of the same type.

The memory 507, in these examples, may be, for example, a random access memory or any other suitable volatile or non-volatile storage device. The persistent storage 509 may take various forms depending on the particular implementation. For example, the persistent storage 509 may contain one or more components or devices. For example, the persistent storage 509 may be a hard drive, a flash memory, a rewritable optical disk, a rewritable magnetic tape, or some combination of the above. The media used by the persistent storage 509 also may be removable. For example, a removable hard drive may be used for the persistent storage 509.

The communications unit 511, in these examples, provides for communications with other data processing systems or communication devices. In these examples, the communications unit 511 may be a network interface card. The communications unit 511 may provide communications through the use of either or both physical and wireless communication links.

The input/output unit 513 allows for the input and output of data with other devices that may be connected to the computing device 502. For example, the input/output unit 513 may provide a connection for user input through a keyboard and mouse. Further, the input/output unit 513 may send output to a processing device. In the case in which the computing device 502 is a cellular phone, the input/output unit 513 may also allow devices to be connected to the cellular phone, such as microphones, headsets, and controllers. The display provides a mechanism to display information to a user, such as a graphical user interface.

Instructions for the operating system and applications or programs are located on the persistent storage 509. These instructions may be loaded into the memory 507 for execution by the processor unit 505. The processes of the different embodiments may be performed by the processor unit 505 using computer-implemented instructions, which may be located in a memory, such as the memory 507. These instructions are referred to as program code, computer-usable program code, or computer-readable program code that may be read and executed by a processor in the processor unit 505. The program code in the different embodiments may be embodied on different physical or tangible computer-readable media, such as the memory 507 or the persistent storage 509.

Program code 517 is located in a functional form on a computer-readable media 519 and may be loaded onto or transferred to the computing device 502 for execution by the processor unit 505. The program code 517 and the computer-readable media 519 form computer program product 521 in these examples. In one embodiment, the computer program product 521 is the embroidery application 104 or 204 described in FIGS. 1-3. In this embodiment, the program code 517 may include computer-usable program code capable of receiving an embroidery design inputted by a user of a communication device to form a user-customized embroidery design. The user is associated with a user account. The program code 517 may also include computer-usable program code capable of saving the user-customized embroidery design on the communication device in response to receiving a save request from the user to save the user-customized embroidery design on the communication device. The program code 517 may also include computer-usable program code capable of initiating a monetary charge to the user account in response to saving the user-customized embroidery design on the communication device.

In another embodiment, the program code 517 may include computer-usable program code capable of receiving an embroidery design inputted by a user of a communication device to form a user-customized embroidery design. The user is associated with a user account. The program code 517 may also include computer-usable program code capable of to converting the user-customized embroidery design to a user-defined file format, saving the user-customized embroidery design on the communication device in response to receiving a save request from the user to save the user-customized embroidery design on the communication device, and initiating a charge to the user account for the user-customized embroidery design created using the embroidery application in accordance with a transactional scheme. Any combination of the above-mentioned computer-usable program code may be implemented in the program code 517, and any functions of the illustrative embodiments may be implemented in the program code 517.

In one example, the computer-readable media 519 may be in a tangible form, such as, for example, an optical or magnetic disc that is inserted or placed into a drive or other device that is part of the persistent storage 509 for transfer onto a storage device, such as a hard drive that is part of the persistent storage 509. In a tangible form, the computer-readable media 519 also may take the form of a persistent storage, such as a hard drive or a flash memory that is connected to the computing device 502. The tangible form of the computer-readable media 519 is also referred to as computer recordable storage media.

Alternatively, the program code 517 may be transferred or deployed to the computing device 502 from the computer-readable media 519 through a communication link to the communications unit 511 or through a connection to the input/output unit 513. Such a transfer may be executed in response to a request from the user for an embroidery application. The communication link or the connection may be physical or wireless in the illustrative examples. The computer-readable media 519 also may take the form of non-tangible media, such as communication links or wireless transmissions containing the program code 517. In one embodiment, the program code 517 is delivered to the computing device 502 over the Internet.

The different components illustrated for the computing device 502 are not meant to provide architectural limitations to the manner in which different embodiments may be implemented. The different illustrative embodiments may be implemented in a data processing system including components in addition to or in place of those illustrated for computing device 502. Other components shown in FIG. 6 can be varied from the illustrative examples shown.

As one example, a storage device in the computing device 502 is any hardware apparatus that may store data. The memory 507, the persistent storage 509, and the computer-readable media 519 are examples of storage devices in a tangible form.

In another example, a bus system may be used to implement the communications fabric 503 and may be comprised of one or more buses, such as a system bus or an input/output bus. Of course, the bus system may be implemented using any suitable type of architecture that provides for a transfer of data between different components or devices attached to the bus system. Additionally, the communications unit 511 may include one or more devices used to transmit and receive data, such as a modem or a network adapter. Further, a memory may be, for example, the memory 507 or a cache such as found in an interface and memory controller hub that may be present in the communications fabric 503.

Although the illustrative embodiments described herein have been disclosed in the context of certain illustrative, non-limiting embodiments, it should be understood that various changes, substitutions, permutations, and alterations can be made without departing from the scope of the invention as defined by the appended claims. It will be appreciated that any feature that is described in a connection to any one embodiment may also be applicable to any other embodiment.

What is claimed is:

1. A method for conducting embroidery design transactions, the method comprising:
receiving an embroidery design inputted by a user of a communication device to form a user-customized embroidery design, the user associated with a user account;
responsive to receiving a save request from the user to save the user-customized embroidery design on the communication device, saving the user-customized embroidery design on the communication device; and
initiating a monetary charge to the user account in response to saving the user-customized embroidery design on the communication device.

2. The method of claim 1, wherein initiating the monetary charge to the user account comprises initiating a single monetary charge to the user account in response to each user-customized embroidery design saved on the communication device.

3. The method of claim 1, further comprising:
receiving user account data from the user, the user account data comprising user financial data; and
associating the user account data to the user account.

4. The method of claim 3 wherein the user financial data comprises credit card data.

5. The method of claim 1, wherein saving the user-customized embroidery design on the communication device comprises:
converting the user-customized embroidery design to a file having a file format; and
saving the file on the communication device.

6. The method of claim 5, wherein the file format is one or more of the following formats: CND, CSD, DAT, DSB, DST, DSZ, EXP, HUS, JEF, KSM, PCM, PCS, PES, SHV, TAP, UXY, VIP, XXX, ZSK, POF, EMB, or ART.

7. The method of claim 5, further comprising:
receiving a user selection of the file format prior to converting the user-customized embroidery design.

8. The method of claim 1, wherein initiating the monetary charge to the user account in response to saving the user-customized embroidery design on the communication device comprises initiating the monetary charge to the user account in accordance with a transactional scheme, the transactional scheme comprising one of a pay-per-design scheme, a subscription scheme, a bulk-purchase scheme, or a time-based scheme.

9. The method of claim 1, wherein initiating the monetary charge to the user account comprises:
determining the monetary charge amount based on a number of stitches contained in the user-customized embroidery design; and
initiating the monetary charge to the user account for the determined monetary charge amount.

10. The method of claim 1, wherein initiating the monetary charge to the user account comprises sending a monetary charge request to a billing engine implemented on a data processing system other than the communication device.

11. A method for deploying computer readable code for conducting embroidery design transactions to a user, the method comprising:
receiving a user request for an embroidery application, the embroidery application comprising computer usable program code to receive an embroidery design inputted by a user of a communication device to form a user-customized embroidery design, the user associated with a user account; convert the user-customized embroidery design to a user-defined file format; save the user-customized embroidery design on the communication device in response to receiving a save request from the user to save the user-customized embroidery design on the communication device; and initiate a charge to the user account for the user-customized embroidery design created using the embroidery application in accordance with a transactional scheme when the computer usable program code is deployed in the communication device; and
deploying the embroidery application to the communication device.

12. The method of claim 11, further comprising:
installing the embroidery application on the communication device.

13. An embroidery design transactional system comprising:
an embroidery application implementable on a communication device, the embroidery application comprising:
an embroidery design editor to receive input from a user of the communication device to form a user-customized embroidery design, the user associated with a user account;
an embroidery design saving module to save the user-customized embroidery design on the communication device; and
a transaction engine to initiate a charge to the user account in accordance with a transactional scheme.

14. The system of claim 13, wherein the embroidery design saving module further comprises a file conversion engine to convert the user-customized embroidery design to a file having a predetermined file format, the embroidery design saving module saving the file on the communication device.

15. The system of claim 13, wherein the transactional scheme is a pay-per-design scheme, and wherein the transaction engine initiates a single monetary charge to the user account for each user-customized embroidery design saved to the communication device.

16. The system of claim 13, wherein the transactional scheme is a subscription scheme, and wherein the transaction engine initiates a monetary charge to the user account at predetermined time intervals.

17. The system of claim 13, wherein the transactional scheme is a bulk-purchase scheme allowing the user to save a predetermined number of user-customized embroidery designs, and wherein the transaction engine initiates the charge to the user account by decrementing a current number of user-customized embroidery designs to which the user is allowed when the embroidery design saving module saves the user-customized embroidery design on the communication device.

18. The system of claim 13, wherein the transactional scheme is a time-based scheme, and wherein the transaction engine initiates the charge to the user account based on an amount of time the user uses the embroidery application.

19. The system of claim 13, further comprising:
a billing module implementable in a server that is separate from the communication device, the server in data communication with the embroidery application, the billing module to charge the user in response to the transaction engine initiating the charge.

20. The system of claim 13, further comprising:
the communication device associated with the user, the communication device comprising a storage, the embroidery application at least partially implemented on the communication device;
wherein the embroidery design saving module saves the user-customized embroidery design on the storage of the communication device.
